(19) United States
(12) Patent Application Publication
(10) Pub. No.: US 2025/0387927 A1
(43) Pub. Date: Dec. 25, 2025

(54) ROBOT ASSEMBLY

(71) Applicant: Roboe Technologies Inc., Seoul (KR)

(72) Inventors: Kyung Tae HONG, Yongin-si (KR); Jeong Woo LEE, Yongin-si (KR); Young Hwa HONG, Yongin-si (KR); Dae Jin KIM, Seoul (KR); Ji Sung KO, Suwon-si (KR)

(73) Assignee: Roboe Technologies Inc., Seoul (KR)

(21) Appl. No.: 19/317,433

(22) Filed: Sep. 3, 2025

Related U.S. Application Data
(63) Continuation of application No. PCT/KR2024/002613, filed on Feb. 28, 2024.

(30) Foreign Application Priority Data
Mar. 3, 2023 (KR) 10-2023-0028599
Feb. 27, 2024 (KR) 10-2024-0028359

(51) Int. Cl. B25J 17/00; B25J 19/02

(52) U.S. Cl. CPC B25J 17/00; B25J 19/023

(57) ABSTRACT

Disclosed is a robot assembly including: a base; a robot comprising a first joint module which is provided to rotate about a first rotary axis, which is a virtual straight line extending in a first direction, with respect to the base; a camera tower including a tower frame, of which the position relative to the base is fixed, and a camera connected to the tower frame; and a coupler which connects the base, the robot, and the tower frame, wherein the coupler includes: a fixing portion which fixes the base and the camera tower to each other; and a rotation portion to which the first joint module is fixed and which is provided to rotate about the first rotary axis with respect to the fixing portion.

### CROSS-REFERENCE TO RELATED APPLICATION

This application Continuation of International Application No. PCT/KR2024/002613, filed on Feb. 28, 2024, which claims priority to and the benefit of Korean Patent Application No. 10-2023-0028599, filed on Mar. 3, 2023, and Korean Patent Application No. 10-2024-0028359, filed on Feb. 27, 2024, the disclosures of which are incorporated herein by reference in their entirety.

### TECHNICAL FIELD

The present invention relates to a robot assembly.

### BACKGROUND ART

Recently, development of industrial robots that can handle relatively high loads and collaborate with workers in various industrial sites is actively underway. Such a robot may include a plurality of joints that can rotate relative to each other, a gripping portion that moves to a target position due to movement of the plurality of joints and can grip an object, a camera for determining the location of the target object, and the like.

Cameras provided in conventional robots have been provided so that they can move together with the gripping portion due to the movement of the plurality of joints. Meanwhile, when a position of the camera is dependent on the movement of the plurality of joints, a region of which an image can be captured by the camera continuously changes due to the movement of the plurality of joints.

In this way, when the region of which an image can be captured by the camera continuously changes due to the movement of the plurality of joints, there is a problem in that consistency in the region of which an image can be captured by the camera is not ensured.

### DETAILED DESCRIPTION OF INVENTION

### Technical Problem

An object of the present invention is to provide a robot assembly equipped with a camera having an independent region of which an image may be captured regardless of movement of a plurality of joints.

Further, an object of the present invention is to provide a robot assembly equipped with a camera in which consistency in the region of which an image can be captured is ensured.

### Technical Solution

According to one aspect of the present invention to achieve the above purpose, there is provided a robot including a base, a robot including a first joint module provided to rotate about a first rotary axis, which is a virtual straight line which extends in a first direction, with respect to the base, a camera tower including a tower frame, of which a position relative to the base is fixed, and a camera connected to the tower frame, and a coupler configured to connect the base, the robot, and the tower frame, wherein the coupler includes a fixing portion which fixes the base and the camera tower to each other, and a rotation portion to which the first joint module is fixed and which is provided to rotate about the first rotary axis with respect to the fixing portion.

Further, there may be provided a robot in which the fixing portion may includes a first fixing member surrounded by the rotation portion and fixed to the tower frame, and a second fixing member configured to connect the first fixing member and the base so that the first fixing member is fixed to the base, and the second fixing member may be spaced apart from the first joint module in a direction intersecting the first direction.

Further, there may be provided a robot in which the second fixing member may be disposed to pass through an interior of the first joint module.

Further, there may be provided a robot in which the first direction may be parallel to an up-down direction, a through hole may be formed to have a shape passing through an upper end portion of the first joint module in the up-down direction, and the second fixing member may be disposed to pass through the through hole and spaced apart from a region which defines the through hole in the first joint module.

Further, there may be provided a robot in which an upper end portion of the second fixing member may be disposed above the first joint module and engaged with a lower end portion of the first fixing member.

Further, there may be provided a robot in which the second fixing member may overlap the first rotary axis.

Further, there may be provided a robot in which the rotation portion may include a first rotation member of which an inner circumferential surface is in close contact with an outer circumferential surface of the first fixing member, and a second rotation member configured to connect the first rotation member and the first joint module so that the first joint module is fixed to the first rotation member.

Further, there may be provided a robot in which the first fixing member and the first rotation member may each be provided as a bearing, the first fixing member may form an inner ring of the bearing, and the first rotation member may form an outer ring of the bearing.

Further, there may be provided a robot in which the first joint module may be disposed between the base and the tower frame in the first direction.

Further, there may be provided a robot in which the robot may further include an extension portion which extends in a second direction intersecting the first direction, one end portion of the extension portion in the second direction may be connected to the first joint module, and the other end portion of the extension portion in the second direction may be spaced apart from the camera tower in the second direction.

Further, there may be provided a robot in which the robot may further include a second joint module of which one end portion in the second direction is rotatably connected to the other end portion of the extension portion in the second direction, and a first link which extends in a first link direction intersecting the second direction and of which one end portion in the first link direction is connected to one end portion of the second joint module in the first link direction, and the second joint module may be provided to rotate about a second rotary axis, which is a virtual straight line extending in the second direction, with respect to the extension portion.

Further, there may be provided a robot in which the robot may further include a third joint module of which one end portion in the first link direction is connected to the other end portion of the first link in the first link direction, the third joint module may include a first joint portion fixed to the first link and a second joint portion rotatably connected to the first joint portion, and the second joint portion may be disposed between the camera tower and the first joint portion in the second direction and spaced apart from the camera tower in the second direction.

Further, there may be provided a robot in which the camera may be rotatably connected to the tower frame and may be provided to rotate about a camera rotary axis, which is a virtual straight line extending parallel to the first rotary axis, with respect to the tower frame.

Further, there may be provided a robot in which the camera rotary axis and the first rotary axis may overlap each other.

Further, there may be provided a robot in which the camera may be provided as a plurality of cameras, the plurality of cameras may include a first camera and a second camera spaced apart from each other in the first direction, the first camera may be oriented in a first image capturing direction intersecting the first direction, and the second camera may be oriented in a second image capturing direction intersecting the first direction and the first image capturing direction.

### Advantageous Effects

A robot assembly according to the present invention includes a camera having an independent region of which an image can be captured regardless of movement of a plurality of joints, thereby having an effect in which consistency in the region of which an image can be captured is ensured.

### DESCRIPTION OF DRAWINGS

FIG. 1 is a perspective view of a robot assembly according to an embodiment of the present invention.

FIG. 2 is a view showing a camera tower, a coupler, and a first joint module according to the embodiment of the present invention.

FIG. 3 is a cross-sectional view along line A-A′ of FIG. 1.

FIG. 4 is a view showing an interior of a first joint module according to the embodiment of the present invention.

FIG. 5 is a view showing a camera tower according to the embodiment of the present invention.

FIG. 6 is a view showing a state in which a camera of FIG. 5 is rotated with respect to a tower frame.

FIG. 7 is a view showing a state in which the camera of FIG. 5 is rotated with respect to a tower frame.

### MODES OF THE INVENTION

Hereinafter, some embodiments of the present invention will be described in detail through exemplary drawings. When reference signs are added to components of each of the drawings, it should be noted that identical components are given the same signs as much as possible even when they are shown on different drawings. In addition, when embodiments of the present invention are described, when it is determined that a specific description of a related known configuration or function hinders understanding of the embodiment of the present invention, the detailed description will be omitted.

Hereinafter, a robot assembly 1 according to the present invention will be described with reference to the accompanying drawings.

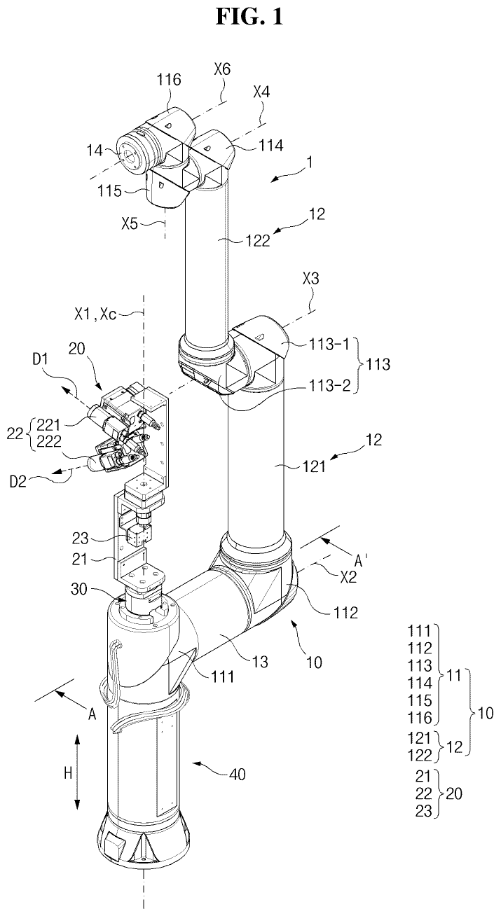

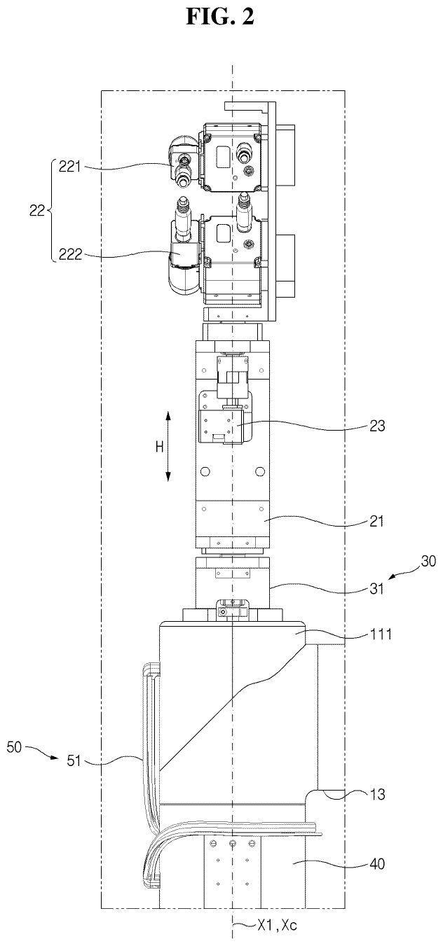

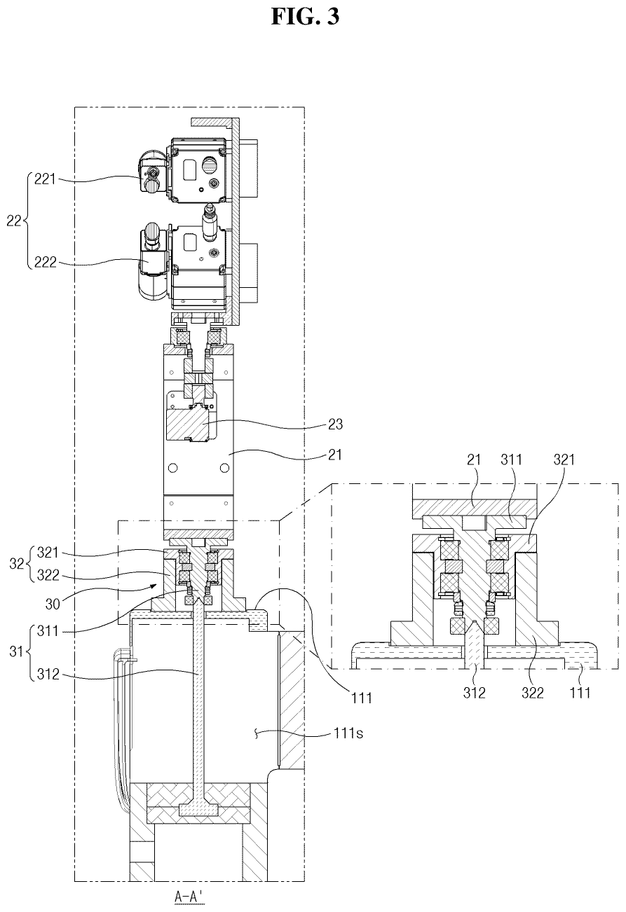

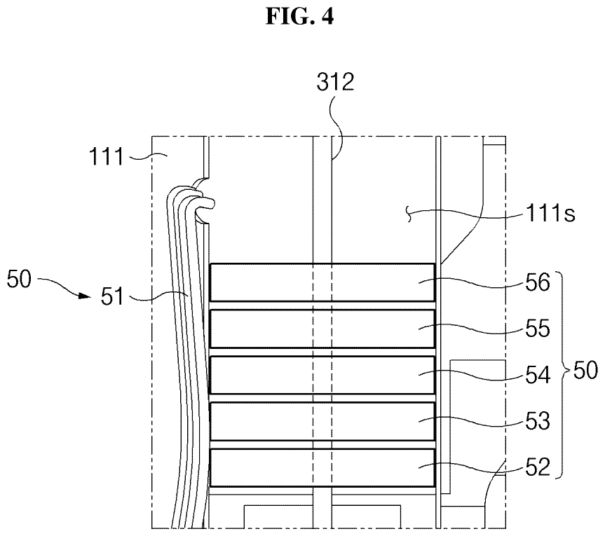

FIG. 1 is a perspective view of a robot assembly according to an embodiment of the present invention, FIG. 2 is a view showing a camera tower, a coupler, and a first joint module according to the embodiment of the present invention, FIG. 3 is a cross-sectional view along line A-A′ of FIG. 1, and FIG. 4 is a view showing an interior of a first joint module according to the embodiment of the present invention.

Referring to FIGS. 1 to 4, the robot assembly 1 may be a collaborative robot capable of collaborating with workers in an industrial site. The robot assembly 1 may capture an image of an object that will be gripped (a grip target object) and grip the grip target object by determining a position relative to the grip target object based on a captured result. The robot assembly 1 may include a robot 10, a camera tower 20, a coupler 30, a base 40, and a driving unit 50.

The robot 10 may be a multi-joint robot having a plurality of joints. The robot 10 may be connected to, for example, a moving unit (for example, an automated guided vehicle (AGV)) that can move on the ground. The AGV may be, for example, a component included in the robot assembly 1. The robot 10 may include a plurality of joint modules 11, a plurality of links 12, an extension portion 13, and a gripping portion 14.

The plurality of joint modules 11 may include a first joint module 111, a second joint module 112, a third joint module 113, a fourth joint module 114, a fifth joint module 115, and a sixth joint module 116.

The first joint module 111 may be provided to rotate with respect to the base 40. For example, the first joint module 111 may be provided to rotate about a first rotary axis X1 with respect to the base 40. The first rotary axis X1 may be a virtual straight line extending in a first direction. The first direction may be, for example, an up-down direction H.

The first direction may include a 1-1 direction and a 1-2 direction. The 1-1 direction may be defined as a direction in which the first joint module 111 faces the camera tower 20. The 1-2 direction may be defined as a direction opposite to the 1-1 direction. The first rotary axis X1 may be a virtual straight line passing through the base, the first joint module 111, and the camera tower 20.

This first joint module 111 may be disposed between the camera tower 20 and the base 40 in the up-down direction H. For example, the camera tower 20, the first joint module 111, and the base 40 may be sequentially disposed in the up-down direction H. As a more detailed example, the first joint module 111 may be disposed at the lower side (in the 1-2 direction) with respect to the camera tower 20, and at the upper side (in the 1-1 direction) with respect to the base 40. An empty space 111s (hereinafter, an internal space 111s) may be formed inside the first joint module 111.

The second joint module 112 may be disposed to rotate about a second rotary axis X2 with respect to the first joint module 111. The second rotary axis X2 may be a virtual straight line which extends in a second direction intersecting the first direction. For example, the second direction may be perpendicular to the first direction. The second direction may include a 2-1 direction and a 2-2 direction. The 2-1 direction may be defined as a direction in which the first joint module 111 faces the second joint module 112. The 2-2 direction may be defined as a direction opposite to the 2-1 direction.

Additionally, the second rotary axis X2 may intersect the first rotary axis X1. The second joint module 112 and the first joint module 111 may be disposed to be spaced apart from each other in the second direction with the extension portion 13 interposed therebetween. For example, an end portion of the second joint module 112 in the 2-2 direction may be rotatably connected to an end portion of the extension portion 13 in the 2-1 direction.

The third joint module 113 may be disposed to be spaced apart from the second joint module 112 in a first link direction. For example, the third joint module 113 and the second joint module 112 may be spaced apart from each other in the first link direction, which will be described below, with the first link 121 interposed therebetween. The first link direction may be a direction in which the first link 121 extends. The first link direction may intersect the second direction. For example, the first link direction may be perpendicular to the second direction.

Additionally, the first link direction may be formed to be parallel to or intersect the first direction as the second joint module 112 rotates with respect to the first joint module 111. The third joint module 113 may include a first joint portion 113-1 and a second joint portion 113-2.

The first joint portion 113-1 may be fixed to the first link 121. For example, the first joint portion 113-1 may not rotate with respect to the first link 121 and the second joint module 112. The first link direction may include a 1-1 link direction and a 1-2 link direction. The 1-1 link direction may be defined as a direction in which the second joint module 112 faces the third joint module 113. The 1-2 link direction may be defined as a direction opposite to the 1-1 link direction. An end portion of the first joint portion 113-1 in the 1-2 link direction may be connected to an end portion of the first link 121 in the 1-1 link direction.

The second joint portion 113-2 may be rotatably connected to the first joint portion 113-1. For example, the second joint portion 113-2 may rotate about a third rotary axis X3 with respect to the first joint portion 113-1. The third rotary axis X3 may be defined as a virtual straight line which extends in a third direction intersecting the first link direction. For example, the third direction may be perpendicular to the first link direction. The third direction may be parallel to the second direction. In other words, the second rotary axis X2 and the third rotary axis X3 may be in parallel and spaced apart from each other in the first link direction. The third direction may include a 3-1 direction and a 3-2 direction.

The 3-1 direction and the 3-2 direction may be, for example, the same as the 2-1 direction and the 2-2 direction, respectively. The second joint portion 113-2 may be disposed at a side of the first joint portion 113-1 in the 2-2 direction. For example, an end portion of the second joint portion 113-2 in the 2-1 direction may be connected to an end portion of the first joint portion 113-1 in the 2-2 direction. As a detailed example, the second joint portion 113-2 may have a shape that protrudes in the 2-2 direction with respect to the first link 121.

In addition, based on when the robot 10 is placed in an attitude in which the 1-1 link direction corresponds to an upward direction, when one side of the robot 10 in the second direction is viewed parallel to the second direction, a part of the second joint portion 113-2 and a part of the camera tower 20 may overlap each other. For example, based on when the robot 10 is placed in the attitude in which the 1-1 link direction corresponds to the upward direction, a part of the second joint portion 113-2 and a part of the camera tower 20 may be disposed to face each other in the second direction. Additionally, the second joint portion 113-2 may be disposed to be spaced apart from the camera tower 20 in the second direction.

The fourth joint module 114 may be disposed to be spaced apart from the second joint portion 113-2 in a second link direction. For example, the fourth joint module 114 and the second joint portion 113-2 may be spaced apart from each other in the second link direction, which will be described below, with the second link 122 interposed therebetween. The second link direction may be referred to as a direction in which the second link 122 extends.

The second link direction may intersect the third direction. For example, the second link direction may be perpendicular to the third direction. Additionally, the second link direction may be formed to be parallel to or intersect the first link direction as the second joint portion 113-2 rotates with respect to the first joint portion 113-1.

The fourth joint module 114 may be fixed to the second link 122. For example, the fourth joint module 114 may not rotate with respect to the second link 122 and the second joint portion 113-2. The second link direction may include a 2-1 link direction and a 2-2 link direction.

The 2-1 link direction may be defined as a direction in which the second joint portion 113-2 faces the fourth joint module 114. The 2-2 link direction may be defined as a direction opposite to the 2-1 link direction. An end portion of the fourth joint module 114 in the 2-2 link direction may be connected to an end portion of the second link 122 in the 2-1 link direction.

The fifth joint module 115 may be rotatably connected to the fourth joint module 114. The fifth joint module 115 may be disposed to rotate about a fourth rotary axis X4 with respect to the fourth joint module 114. The fourth rotary axis X4 may be defined as a virtual straight line which extends in a fourth direction intersecting the second link direction. The fourth rotary axis X4 may be formed, for example, parallel to the third rotary axis X3. Additionally, the fourth rotary axis X4 may be spaced apart from the third rotary axis X3 in the second link direction. The fourth direction may include a 4-1 direction and a 4-2 direction. The 4-1 direction and the 4-2 direction may be, for example, the same as the 3-1 direction and the 3-2 direction, respectively.

The fifth joint module 115 may be disposed at a side of the fourth joint module 114 in the 4-2 direction. For example, an end portion of the fifth joint module 115 in the 4-1 direction may be connected to an end portion of the fourth joint module 114 in the 4-2 direction. As a detailed example, the fifth joint module 115 may have a shape that protrudes in the 4-2 direction with respect to the second link 122.

The sixth joint module 116 may be rotatably connected to the fifth joint module 115. The sixth joint module 116 may be disposed to rotate about a fifth rotary axis X5 with respect to the fifth joint module 115. The fifth rotary axis X5 may be defined as a virtual straight line which extends in a fifth direction intersecting the fourth direction. The fifth direction may, for example, be perpendicular to the fourth direction. The fifth direction may include a 5-1 direction and a 5-2 direction. The 5-1 direction may be defined as a direction in which the fifth joint module 115 faces the sixth joint module 116. The 5-2 direction may be defined as a direction opposite to the 5-1 direction.

The sixth joint module 116 may be disposed at a side of the fifth joint module 115 in the 5-1 direction. For example, an end portion of the sixth joint module 116 in the 5-2 direction may be connected to an end portion of the fifth joint module 115 in the 5-1 direction. The sixth joint module 116 may have a shape which protrudes in the 5-1 direction from the fourth joint module 114.

The plurality of links 12 may include the first link 121 and the second link 122. The first link 121 may be disposed between the second joint module 112 and the first joint portion 113-1 to connect the second joint module 112 and the first joint portion 113-1. The second joint module 112 and the first joint portion 113-1 may be fixed to both ends of the first link 121.

The second link 122 may be disposed between the second joint portion 113-2 and the fourth joint module 114 to connect the second joint portion 113-2 and the fourth joint module 114. The second joint portion 113-2 and the fourth joint module 114 may be fixed to both ends of the second link 122.

The extension portion 13 may extend in the second direction between the first joint module 111 and the second joint module 112. An end portion of the extension portion 13 in the 2-2 direction may be connected to the first joint module 111. Additionally, an end portion of the extension portion 13 in the 2-1 direction may be connected to the second joint module 112. A length of the extension portion 13 extending in the second direction may correspond to a separation distance in the second direction between the second joint module 112 and the camera tower 20.

Through the extension portion 13, each of the second joint module 112, the first link 121, the first joint portion 113-1 and the second joint portion 113-2 may be spaced apart from the camera tower 20 in the second direction. In other words, when the plurality of joint modules 11 and the plurality of links 12 are moved relative to each other through the extension portion 13, the plurality of joint modules 11, the plurality of links 12 and the camera tower 20 can be prevented from interfering with each other.

The gripping portion 14 may grip a grip target object. The gripping portion 14 may be provided as a plurality of suction pads, a hook-shaped gripper, or the like. The gripping portion 14 may be rotatably connected to the sixth joint module 116. The gripping portion 14 may be disposed to rotate about a sixth rotary axis X6 with respect to the sixth joint module 116. The sixth rotary axis X6 may be defined as a virtual straight line which extends in a sixth direction intersecting the fifth direction. For example, the sixth direction may be perpendicular to the fifth direction.

The camera tower 20 may be connected to the robot 10. The camera tower 20 may include a tower frame 21 and a camera 22. The tower frame 21 may form at least a part of the exterior of the camera tower 20. The tower frame 21 may support the camera 22.

The tower frame 21 may be disposed on an upper portion of the first joint module 111. A position of the tower frame 21 relative to the base 40 may be fixed. For example, the tower frame 21 may be provided so as not to rotate with respect to the base 40.

The camera 22 may capture an image of the grip target object. The camera 22 may be rotatably connected to the tower frame 21. For example, the camera 22 may be provided to rotate about a camera rotary axis Xc with respect to the tower frame 21. The camera rotary axis Xc may be a virtual straight line which extends parallel to the first direction. For example, the camera rotary axis Xc may be formed as a virtual straight line identical to the first rotary axis X1. However, the present invention is not limited to the example, and the camera rotary axis Xc may be spaced horizontally from the first rotary axis X1. A plurality of cameras 22 may be provided. The plurality of cameras 22 may include a first camera 221 and a second camera 222.

The first camera 221 may be disposed above the second camera 222. The first camera 221 may be oriented in a first image capturing direction D1 intersecting the first direction to form a first angle with the camera rotary axis Xc. The first image capturing direction D1 may be defined as, for example, a direction vector formed by the sum of an upward vector and a horizontal vector (in a direction perpendicular to the first direction).

The second camera 222 may be disposed to be spaced downward from the first camera 221. The second camera 222 may be oriented in a second image capturing direction D2 intersecting the first direction and the first image capturing direction D1 to form a second angle with the camera rotary axis Xc. The second image capturing direction D2 may be defined as, for example, a direction vector formed by the sum of a downward vector and a horizontal vector (in the direction perpendicular to the first direction).

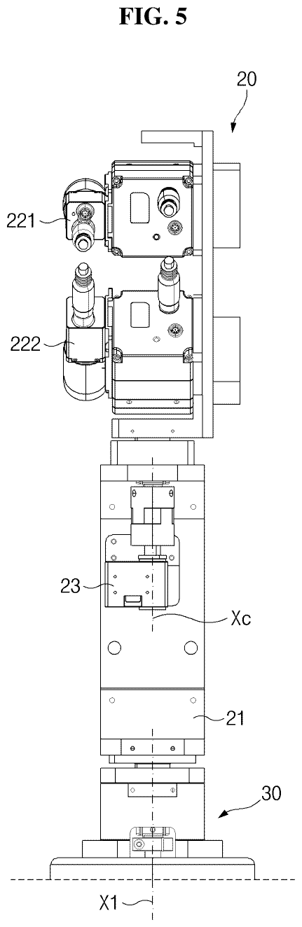

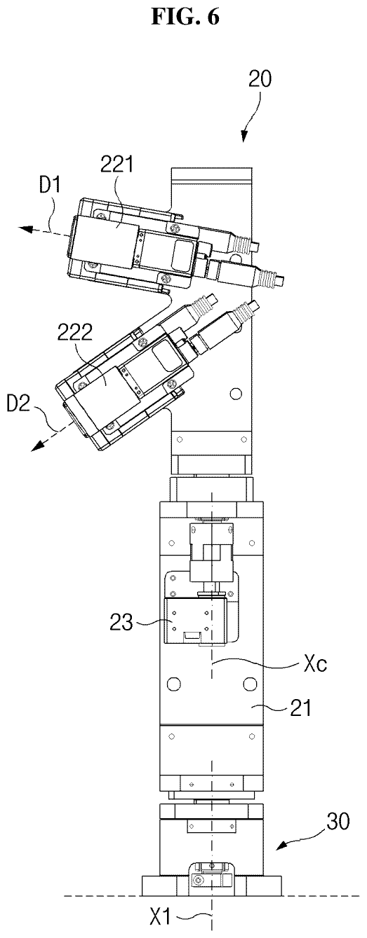

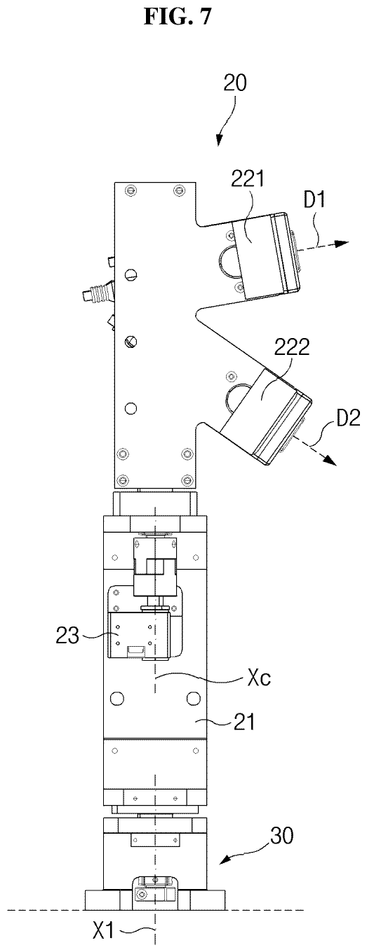

Referring to FIGS. 5 to 7, when the plurality of cameras 22 are rotated in a first rotational direction with respect to the tower frame 21, the first image capturing direction D1 and the second image capturing direction D2 may change. The first rotational direction (or a second rotational direction) may be defined as a clockwise (see FIG. 6) (or counterclockwise (see FIG. 7)) direction when an upper portion of the camera tower 20 is viewed parallel to the up-down direction H.

FIG. 5 is a view showing a camera tower according to the embodiment of the present invention, FIG. 6 is a view showing a state in which the camera of FIG. 5 is rotated with respect to the tower frame, and FIG. 7 is a view showing a state in which the camera of FIG. 5 is rotated with respect to a tower frame.

Referring to FIG. 5, when a direction in which a camera motor 23 faces the tower frame 21 in a horizontal direction is referred to as a camera direction, and a direction perpendicular to the camera direction and the first direction is referred to a reference direction, the camera tower 20 may be placed in a first attitude in which the first image capturing direction D1, the second image capturing direction D2 and the camera direction are all perpendicular to the reference direction.

In addition, referring to FIGS. 6 and 7, when a plurality of cameras 22 are rotated in the first rotational direction (see FIG. 6) (or the second rotational direction (see FIG. 7)) with respect to the tower frame 21, the camera tower 20 may be placed in a second attitude in which the first image capturing direction D1 and the second image capturing direction D2 intersect the camera direction. That is, when the plurality of cameras 22 rotate in the first rotational direction (or the second rotational direction) with respect to the tower frame 21, the camera tower 20 may be switched from the first attitude to the second attitude.

Referring again to FIGS. 2 and 3, the coupler 30 may connect the base 40, the robot 10, and the tower frame 21 to each other. The coupler 30 may include a fixing portion 31 and a rotation portion 32.

The fixing portion 31 may fix the base 40 and the camera tower 20 to each other. For example, the base 40 and the camera tower 20 may be provided so that the base 40 and the camera tower 20 do not rotate relative to each other through the fixing portion 31. An upper portion of the fixing portion 31 may be connected to the camera tower 20, and a lower portion of the fixing portion 31 may be connected to the base 40. The fixing portion 31 may include a first fixing member 311 and a second fixing member 312.

The first fixing member 311 may be fixed to the tower frame 21. For example, the first fixing member 311 may be connected to a lower portion of the tower frame 21. The first fixing member 311 may be disposed to be surrounded by the rotation portion 32.

The first fixing member 311 may be disposed above the first joint module 111. For example, the first fixing member 311 and the first joint module 111 may be disposed to be spaced apart from each other in the first direction.

The second fixing member 312 may connect the first fixing member 311 and the base 40 to each other. The first fixing member 311 may be fixed to the base 40 through the second fixing member 312. An upper end of the second fixing member 312 may be engaged with a lower end of the first fixing member 311.

For example, an upwardly recessed groove may be formed in the lower end of the first fixing member 311, and the upper end of the second fixing member 312 may be inserted into the groove of the first fixing member 311. The groove of the first fixing member 311 and the upper end of the second fixing member 312 may have shapes that correspond to each other.

Additionally, the upper end of the second fixing member 312 may have a shape which extends in the camera direction. For example, the upper end of the second fixing member 312 may have a flat head screwdriver shape. Through the shape of the upper end of the second fixing member 312, the second fixing member 312 may be prevented from rotating with respect to the first fixing member 311 while the upper end of the second fixing member 312 is inserted into the groove of the first fixing member 311.

The second fixing member 312 may have a bar shape which extends in the up-down direction. The second fixing member 312 may be called, for example, a “fixing bar.” The second fixing member 312 may be spaced apart from the first joint module 111 in a direction intersecting the first direction (for example, the horizontal direction).

The second fixing member 312 may be disposed to pass through the internal space 111s. In addition, the internal space 111s may have a rotating body shape with a horizontal cross-section having a ring shape. As a detailed example, the internal space 111s may have a ring-like rotating body shape having a vertical cross-section having a quadrangular shape.

Additionally, the second fixing member 312 may be disposed to pass through a through hole formed in the first joint module 111. The through hole may have a shape that passes through an upper end portion of the first joint module 111 in the up-down direction. The second fixing member 312 may be disposed to be spaced apart from the through hole in a direction (the horizontal direction) intersecting the first direction. For example, the second fixing member 312 may be disposed to be spaced apart from a region defining the through hole in the upper end portion of the first joint module 111. The second fixing member 312 may overlap the first rotary axis X1.

As the second fixing member 312 is disposed so as to not come into contact with the first joint module 111 but to be spaced apart from the first joint module 111, the first joint module 111 may be disposed to rotate about the first rotary axis X1 with respect to the second fixing member 312, the base 40, and the camera tower 20.

A lower portion of the second fixing member 312 may be connected to the base 40. For example, the lower portion of the second fixing member 312 may have a disk shape, and an outer circumferential surface of the lower portion of the second fixing member 312 may be fixed to an inner circumferential surface of the base 40. In other words, the lower portion of the second fixing member 312 may have a disk shape, the upper end portion of the second fixing member 312 may have a flat head screwdriver shape, and a remaining portion of the second fixing member 312 may have a bar shape passing through the internal space 111s.

The rotation portion 32 may be disposed to rotate about the first rotary axis X1 with respect to the fixing portion 31. The first joint module 111 may be fixed to the rotation portion 32. For example, a lower surface of the rotation portion 32 may be connected to an upper surface of the first joint module 111. The rotation portion 32 may include a first rotation member 321 and a second rotation member 322.

The first rotation member 321 may be provided so that its inner circumferential surface is in close contact with an outer circumferential surface of the first fixing member 311. The first rotation member 321 may be provided to rotate about the first rotary axis X1 with respect to the first fixing member 311.

The first rotation member 321 and the first fixing member 311 may form, for example, a bearing. For example, the first fixing member 311 may form an inner ring of the bearing, and the first rotation member 321 may form an outer ring of the bearing. The first rotation member 321 may be fixed to the second rotation member 322.

The second rotation member 322 may connect the first rotation member 321 and the first joint module 111. For example, the second rotation member 322 may fix the first rotation member 321 and the first joint module 111 to each other. In other words, the first rotation member 321, the second rotation member 322, and the first joint module 111 may be provided to rotate about the first rotary axis X1 with respect to the fixing portion 31.

The base 40 may support the robot 10, the camera tower 20, the coupler 30, and the driving unit 50. The base 40 may be mounted on, for example, the automated guided vehicle (AGV). The base 40 may extend in the first direction. In addition, the base 40 may be placed at a lower portion of the first joint module 111.

Referring again to FIG. 4, the driving unit 50 may include a wire 51, a gear 52, a motor 53, an encoder 54, a brake 55, and a printed circuit board (PCB) 56. The wire 51 may provide electrical energy to the gear 52, the motor 53, the encoder 54, the brake 55, and the PCB 56. At least a part of the wire 51 may be wound around the outer surfaces of the first joint module 111 and the base 40. For example, the wire 51 may be disposed to sequentially pass through the interior of each of the sixth joint module 116, the fifth joint module 115, the fourth joint module 114, the second link 122, the third joint module 113, the first link 121, the second joint module 112, the extension portion 13, an upper portion of the PCB 56, a hole horizontally passing through the outer surface of the first joint module 111, a hole horizontally passing through the outer surface of the base 40, and the interior of the base 40. Additionally, the wire 51 may pass through the interior of the base 40 and be electrically connected to the AGV.

The gear 52, the motor 53, the encoder 54, the brake 55 and the PCB 56 may each be provided to provide a driving force to the first joint module 111. The gear 52, the motor 53, the encoder 54, the brake 55, and the PCB 56 may be disposed sequentially in the up-down direction H. In addition, a hollow may be formed to pass through a center of each of the gear 52, the motor 53, the encoder 54, the brake 55, and the PCB 56 in the first direction. The second fixing member 312 may be disposed to pass through the hollow of each of the gear 52, the motor 53, the encoder 54, the brake 55, and the PCB 56.

Additionally, each of the gear, the motor, the encoder, the brake, and the PCB may be provided as a plurality of gears, motors, encoders, brakes, and PCBs that are provided in each of the plurality of joint modules 11. For example, 6 gears, 6 motors, 6 encoders, 6 brakes, and 6 PCBs may be provided for each of the first to sixth joint modules 111, 112, 113, 114, 115, and 116.

In addition, the wire 51 may be disposed to pass through the hollow of each of the plurality of gears, the plurality of motors, the plurality of encoders, the plurality of brakes, and the plurality of PCBs provided in each of the remaining joint modules except the first joint module 111 among the plurality of joint modules 11.

In the description, although all components constituting the embodiment of the present invention have been described as being combined or operating in combination as one, the present invention is not necessarily limited to the embodiment. That is, within the scope of the purpose of the present invention, all of the components may be selectively combined and operated one or more times. In addition, terms such as “include,” “comprise,” or “have” described above, unless specifically stated otherwise, should be interpreted to mean that the corresponding component may be present, and thus, should not be interpreted to exclude other components, but rather to include other components. All terms, including technical or scientific terms, unless otherwise defined, have the same meaning as commonly understood by a person of ordinary skill in the art to which the present invention belongs. Commonly used terms, such as terms defined in the dictionary, should be interpreted to be consistent with their contextual meaning in the relevant art and shall not be interpreted in an idealized or overly formal sense unless expressly defined herein.

The above description is merely an example of the technical idea of the present invention, and those skilled in the art will appreciate that various modifications and variations can be made without departing from the essential characteristics of the present invention. Accordingly, the embodiment disclosed in the present invention is not intended to limit the technical idea of the present invention but to explain it, and the scope of the technical idea of the present invention is not limited by the embodiment. The scope of protection of the present invention should be interpreted by the claims below, and all technical ideas within the scope equivalent thereto should be interpreted as being included in the scope of the rights of the present invention.

1. A robot assembly comprising:
a base;
a robot including a first joint module provided to rotate about a first rotary axis, which is a virtual straight line which extends in a first direction, with respect to the base;
a camera tower including a tower frame, of which a position relative to the base is fixed, and a camera connected to the tower frame; and
a coupler configured to connect the base, the robot, and the tower frame,
wherein the coupler includes:
a fixing portion which fixes the base and the camera tower to each other; and
a rotation portion to which the first joint module is fixed and which is provided to rotate about the first rotary axis with respect to the fixing portion.

2. The robot assembly of claim 1, wherein the fixing portion includes:
a first fixing member surrounded by the rotation portion and fixed to the tower frame; and
a second fixing member configured to connect the first fixing member and the base so that the first fixing member is fixed to the base, and
the second fixing member is spaced apart from the first joint module in a direction intersecting the first direction.

3. The robot assembly of claim 2, wherein the second fixing member is disposed to pass through an interior of the first joint module.

4. The robot assembly of claim 3, wherein the first direction is parallel to an up-down direction,
a through hole is formed to have a shape passing through an upper end portion of the first joint module in the up-down direction, and
the second fixing member is disposed to pass through the through hole and spaced apart from a region which defines the through hole in the first joint module.

5. The robot assembly of claim 4, wherein an upper end portion of the second fixing member is disposed above the first joint module and engaged with a lower end portion of the first fixing member.

6. The robot assembly of claim 2, wherein the second fixing member overlaps the first rotary axis.

7. The robot assembly of claim 2, wherein the rotation portion includes:
a first rotation member of which an inner circumferential surface is in close contact with an outer circumferential surface of the first fixing member; and
a second rotation member configured to connect the first rotation member and the first joint module so that the first joint module is fixed to the first rotation member.

8. The robot assembly of claim 7, wherein the first fixing member and the first rotation member are each provided as a bearing,
the first fixing member forms an inner ring of the bearing, and
the first rotation member forms an outer ring of the bearing.

9. The robot assembly of claim 1, wherein the first joint module is disposed between the base and the tower frame in the first direction.

10. The robot assembly of claim 1, wherein the robot further includes an extension portion which extends in a second direction intersecting the first direction,
one end portion of the extension portion in the second direction is connected to the first joint module, and
the other end portion of the extension portion in the second direction is spaced apart from the camera tower in the second direction.

11. The robot assembly of claim 10, wherein the robot further includes:
a second joint module of which one end portion in the second direction is rotatably connected to the other end portion of the extension portion in the second direction; and
a first link which extends in a first link direction intersecting the second direction and of which one end portion in the first link direction is connected to one end portion of the second joint module in the first link direction, and
the second joint module is provided to rotate about a second rotary axis, which is a virtual straight line extending in the second direction, with respect to the extension portion.

12. The robot assembly of claim 11, wherein the robot further includes a third joint module of which one end portion in the first link direction is connected to the other end portion of the first link in the first link direction,
the third joint module includes a first joint portion fixed to the first link and a second joint portion rotatably connected to the first joint portion, and
the second joint portion is disposed between the camera tower and the first joint portion in the second direction and spaced apart from the camera tower in the second direction.

13. The robot assembly of claim 1, wherein the camera is rotatably connected to the tower frame and is provided to rotate about a camera rotary axis, which is a virtual straight line extending parallel to the first rotary axis, with respect to the tower frame.

14. The robot assembly of claim 13, wherein the camera rotary axis and the first rotary axis overlap each other.

15. The robot assembly of claim 1, wherein the camera is provided as a plurality of cameras,
the plurality of cameras include a first camera and a second camera spaced apart from each other in the first direction,
the first camera is oriented in a first image capturing direction intersecting the first direction, and
the second camera is oriented in a second image capturing direction intersecting the first direction and the first image capturing direction.
